(19) United States
(12) Patent Application Publication
(10) Pub. No.: US 2015/0231445 A1
(43) Pub. Date: Aug. 20, 2015

(54) WRIST EXERCISER

(71) Applicant: NANO-SECOND TECHNOLOGY CO., LTD, New Taipei City (TW)

(72) Inventor: Pei-Sung CHUANG, New Taipei City (TW)

(21) Appl. No.: 14/703,813

(22) Filed: May 4, 2015

Related U.S. Application Data
(63) Continuation-in-part of application No. 13/735,731, filed on Jan. 7, 2013.

(30) Foreign Application Priority Data
Jan. 9, 2012 (TW) 101200515

(51) Int. Cl. A63B 24/00; A63B 21/22; H04Q 9/00; A63B 21/00

(52) U.S. Cl. CPC A63B 24/0062; A63B 21/0004; A63B 21/00076; A63B 21/22; H04Q 9/00; A63B 2021/222

(57) ABSTRACT

A wrist exerciser, for being wirelessly coupled to an information device, includes a wrist strength training device having an opening and an electronic auxiliary device for being inserted into the opening. The electronic auxiliary device includes a device body and a function device disposed inside the device body. The function device includes a processing circuit, at least one sensing circuit coupled to the processing circuit and for acquiring the exercise information of the wrist strength training device, a wireless transmission circuit coupled to the processing circuit and for receiving or transmitting a wireless signal, and an electrical power circuit coupled to the processing circuit and for supplying electrical power. The function device is for acquiring the exercise information and transmitting the exercise information to the information device wirelessly.

### CROSS-REFERENCE TO RELATED APPLICATIONS

This application is a continuation-in-part of U.S. patent application Ser. No. 13/735,731, filed Jan. 7, 2013, which claims priority under 35 U.S.C. §119(a) on Patent Application No(s). 101200515 filed in Taiwan, R.O.C. on Jan. 9, 2012, the entire contents of which are hereby incorporated by reference.

### TECHNICAL FIELD

The disclosure relates to a wrist exerciser, and more particularly to a wrist exerciser with an electronic auxiliary device.

### BACKGROUND

A wrist strength training ball utilizes the principle of a gyroscope in which only a mechanical manner is required to make the wrist strength training ball start rotating. A user holds and rotates the wrist strength training ball in the palm of their hand, to enable the wrist strength training ball to generate a strong rotational force under the effects of a centrifugal force and an inertial force. Therefore, the rotational force is used for exercising the muscles of the user's hands and shoulders.

To provide the user with a visual effect of operating the wrist strength training ball, manufacturers have made the wrist strength training balls with a light emitting effect. For a wrist strength training ball with the light emitting effect, a simple power generator is disposed inside the ball body. Electrical power is generated through the rotation of the wrist strength training ball and then supplied to a light emitting diode disposed inside the ball body.

However, currently the wrist strength training ball is only used for personal muscular strength training, and the additional light emitting diode is only for a visual effect during operation and the light emitting diode is not able to provide more functions.

### SUMMARY

According to an embodiment, a wrist exerciser, for being wirelessly coupled to an information device, includes a wrist strength training device having an opening and an electronic auxiliary device for being inserted into the opening. The electronic auxiliary device includes a device body and a function device disposed inside the device body. The function device includes a processing circuit, at least one sensing circuit coupled to the processing circuit and for acquiring the exercise information of the wrist strength training device, a wireless transmission circuit coupled to the processing circuit and for receiving or transmitting a wireless signal, and an electrical power circuit coupled to the processing circuit and for supplying electrical power. The function device is for acquiring the exercise information and transmitting the exercise information to the information device wirelessly.

### BRIEF DESCRIPTION OF THE DRAWINGS

The disclosure will become more fully understood from the detailed description given herein below for illustration only and thus does not limit the disclosure, wherein:

FIG. 1 is a schematic 3D view of an electronic auxiliary device and a wrist strength training device having the same according to an embodiment;

FIG. 2 is a schematic exploded view of FIG. 1;

FIG. 3 is a schematic 3D view of an electronic auxiliary device and a wrist strength training device having the same according to another embodiment;

FIG. 4 is a schematic block diagram of a function device in FIG. 1;

FIG. 5 is a schematic 3D view of an electronic auxiliary device and a wrist strength training device having the same according to another embodiment;

FIG. 6 is a schematic exploded view of FIG. 5;

FIG. 7 is a schematic 3D view of a ring cover and buckle structures in FIG. 6 being joined;

FIG. 8 is a schematic perspective view of a wrist exerciser with an electronic auxiliary device and a wrist strength training device according to an embodiment;

FIG. 9 is a schematic exploded view of FIG. 8;

FIG. 10 is a block diagram of a function device of FIG. 8;

FIG. 11 is a schematic exploded view of an electronic auxiliary device and a wrist strength training device according to an embodiment; and

FIG. 12 is a schematic perspective view of FIG. 11;

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

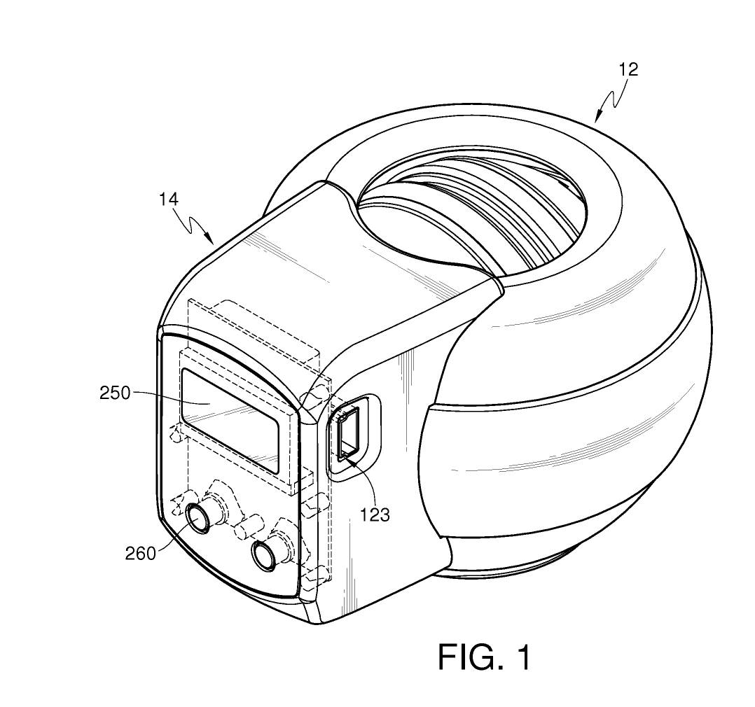

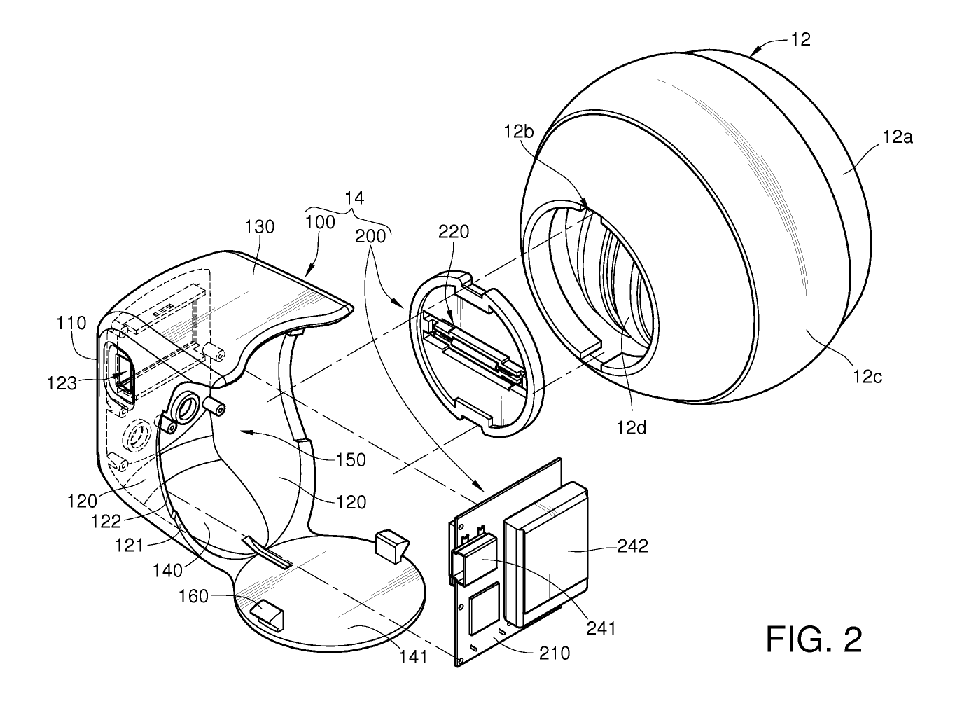

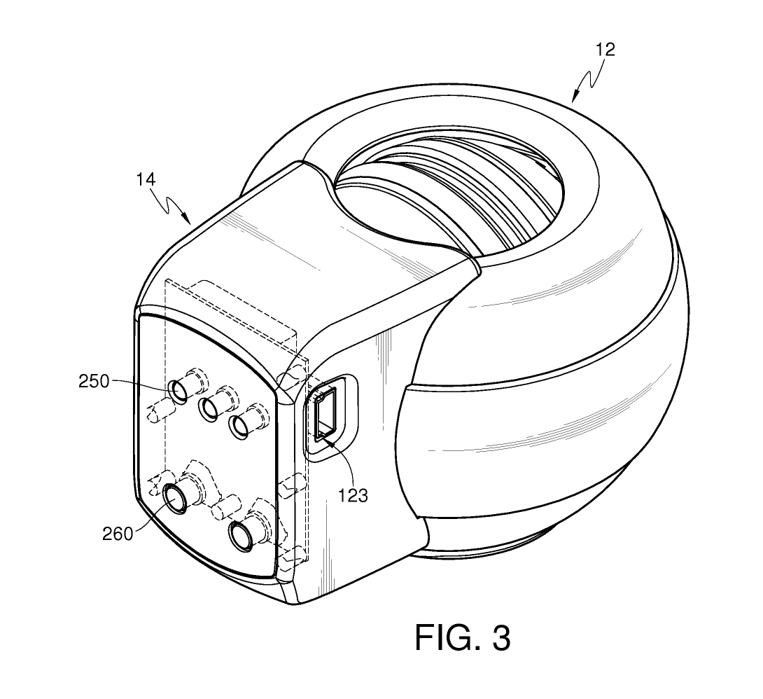

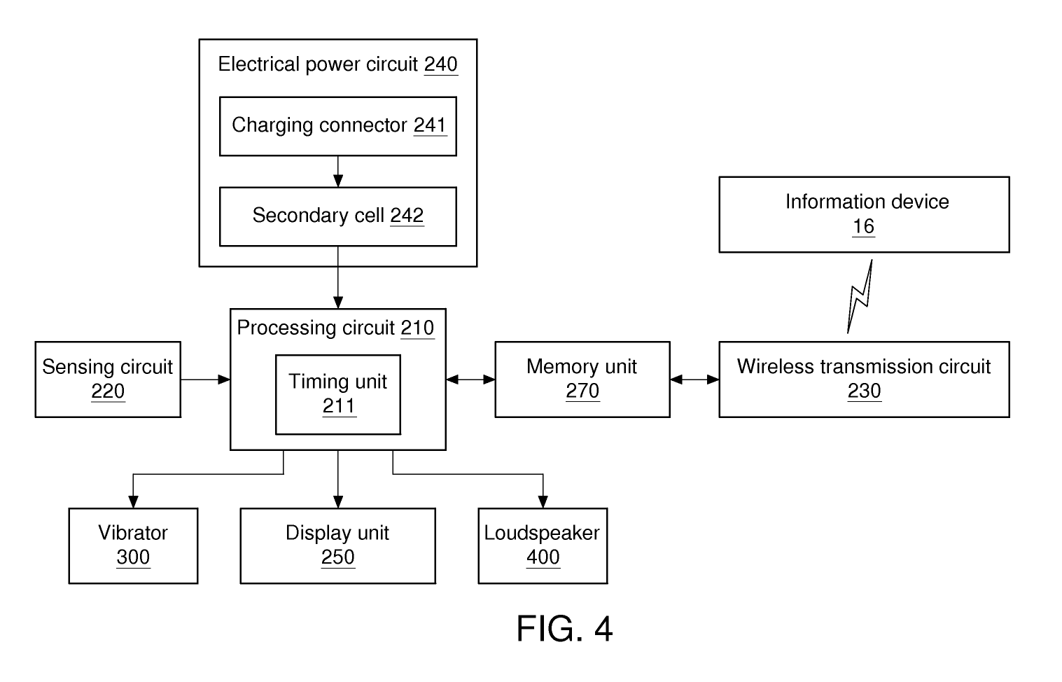

Please refer to FIG. 1 to FIG. 4, FIG. 1 is a schematic 3D view of an electronic auxiliary device and a wrist strength training device having the same according to an embodiment; FIG. 2 is a schematic exploded view of FIG. 1; FIG. 3 is a schematic 3D view of an electronic auxiliary device and a wrist strength training device having the same according to another embodiment; and FIG. 4 is a schematic block diagram of a function device in FIG. 1.

In this embodiment, an electronic auxiliary device 14 is adapted for being joined with a wrist strength training device 12. The electronic auxiliary device 14 acquires the exercise information of the wrist strength training device 12 and transmits the exercise information to an information device 16 wirelessly, so that a user is able to interact with the information device 16 through the wrist strength training device 12.

In this embodiment, the wrist strength training device 12 comprises a ball body 12a and a ring cover 12c surrounding the outer surface of the ball body 12a. A rotating body 12d is disposed inside the ball body 12a and is able to rotate inside the ball body 12a. In this and some other embodiments, the user holds and rotates the ball body 12a in the palm of their hand to make the rotating body 12d start rotating. Also, the user controls the speed to rotate the ball body 12a so as to change the rotational speed of the rotating body 12d.

In this embodiment, the information device 16 is, for example, a desktop computer, a notebook computer, a gaming device, a smart phone, or a tablet computer.

In detail, the electronic auxiliary device 14 comprises a device body 100 and a function device 200. The device body 100 comprises a lateral wall 110, two sidewalls 120, a top wall 130, and a bottom wall 140. The lateral wall 110, the two sidewalls 120, the top wall 130, and the bottom wall 140 form an accommodating chamber 150.

In this embodiment, each of the two sidewalls 120 has a groove 121. Each of the grooves 121 has the arc surface. The arc surface faces the wrist strength training device 12 and matches the outer surface of the ball body 12a. In this embodiment and some other embodiments, each of the grooves 121 has a notch 122. The shape of the notches 122 matches the outer surface of the ring cover 12c. Therefore, the electronic auxiliary device 14 is tightly attached to the wrist strength training device 12.

In this embodiment, a connecting plate 141 extends from the bottom wall 140. Also, an auxiliary unit, for example, a screwing unit or a fastening, is disposed at the connecting plate 141. In this embodiment, the auxiliary unit is a fastening. A fasten structure 160 is disposed at the connecting plate 141, and a slot 12b is disposed at the ball body 12a. The fasten structure 160 is joined to the slot 12b, so that the device body 100 is disposed on the wrist strength training device 12.

Please refer to FIG. 4, FIG. 4 is a schematic block diagram of the function device in FIG. 1. The function device 200 is disposed inside the accommodating chamber 150 and the function device 200 comprises a processing circuit 210, at least one sensing circuit 220, a wireless transmission circuit 230, and an electrical power circuit 240. The processing circuit 210 is, for example, a microprocessor or a controller, and the processing circuit 210 is adapted for computing and processing the information received by the function device 200. The processing circuit 210 comprises a timing unit 211. The timing unit 211 is adapted for recording a training time so as to compute a training intensity within a period of time by the processing circuit 210.

The sensing circuit 220 is coupled to the processing circuit 210 and is adapted for acquiring the exercise information of the wrist strength training device 12. In detail, the sensing circuit 220 has a tachometer, an accelerometer, or both a tachometer and an accelerometer. The tachometer is adapted for acquiring the rotational speed information of the operation of the wrist strength training device 12, that is, the rotational speed of the rotating body 12d inside the ball body 12a (a magnet (not shown) is disposed inside the rotating body 12d and the rotational speed is measured by a magnetic sensor). The accelerometer is adapted for acquiring a gravitational acceleration of the wrist strength training device 12, that is, the movement information of the ball body 12a is acquired by the accelerometer. The rotational speed information and the movement information are parameters for the interaction between the user and the information device 16. Therefore, when the user uses the wrist strength training device 12, the wrist strength training and the interaction with the information device 16 are achieved at the same time. The interaction manners of the wrist strength training device 12 and the information device 16 are described below.

The wireless transmission circuit 230 is coupled to the processing circuit 210 and is adapted for receiving or transmitting a wireless signal. The wireless transmission circuit 230 is, for example, a radio frequency (RF) module circuit, a Bluetooth transmission module circuit, or an US Institute of Electrical and Electronics Engineers (IEEE) 802 standard wireless transmission module circuit. In this embodiment, the exercise information acquired by the sensing circuit 220 is transmitted to the information device 16 through the wireless transmission circuit 230, so that a training result is further computed by the information device 16 (for example, an amount of the exercise or the calorie burned per period of time of the exercise). In other embodiments, an application program inside the information device 16 is operated according to the exercise information.

The electrical power circuit 240 is coupled to the processing circuit 210 and is adapted for storing and supplying electrical power to the processing circuit 210, the sensing circuit 220, and the wireless transmission circuit 230. The electrical power circuit 240 comprises a charging connector 241 and a secondary cell 242. The charging connector 241 is coupled to the secondary cell 242, and one of the two sidewalls 120 has an opening 123 exposing the charging connector 241. Therefore, when the electrical power of the electronic auxiliary device 14 is insufficient, the charging connector 241 is capable of charging the secondary cell by connecting a charger through the opening 123 in real time.

In this and some other embodiments, the function device 200 further comprises at least one display unit 250. The display unit 250 is a liquid crystal display (as FIG. 1) or a light emitting diode (as FIG. 3). When the display unit 250 is the liquid crystal display, the electronic auxiliary device 14 acquires the exercise information of the wrist strength training device 12 or the training result computed by the information device 16 is displayed on the liquid crystal display in a picture form or a text form. When the display unit 250 is the light emitting diode, the operating condition of the wrist strength training device 12 is reminded to the user by turning the light on or off.

In this and some other embodiments, the function device 200 further comprises at least one control unit 260, and the control unit 260 is an arrow key or a button, so that the user is able to move a pointer to select an operation or to cancel an operation.

In this and some other embodiments, the function device 200 further comprises a memory unit 270, so that the exercise information acquired by the sensing circuit 220 is first stored in the memory unit 270 and then transmitted to the information device 16 through the wireless transmission circuit 230.

In this and some other embodiments, the electronic auxiliary device 14 further comprises a vibrator 300. The vibrator 300 is coupled to the function device 200, and generates a vibration response according to the interaction information output by the information device 16, so that the user experiences the realistic interactions.

Additionally, the electronic auxiliary device 14 further comprises a loudspeaker 400. The loudspeaker 400 is coupled to the function device 200, and generates an audio response according to the interaction information output by the information device 16, so that the user experiences the audio reminders or auditory enjoyments.

In order to provide the wrist strength training device 12 an entertaining effect in addition to exercising, in this and some other embodiments, the wrist strength training device 12 interacts with the information device 16 through the electronic auxiliary device 14.

For example, the sensing circuit 220 has both a tachometer and an accelerometer, and an application program simulating a flight is executed in the information device 16, so that the user is able to manipulate the motion of the aircraft in the application program by using the wrist strength training device 12. In this and some other embodiments, the user rotates the wrist strength training device 12 so that the wrist strength training device 12 generates the exercise information (the rotational speed information and the movement information) and transmits the exercise information to the information device 16 through the wireless transmission circuit 230 so as to manipulate the motion of the aircraft in the application program. For instance, the user steers the aircraft through the movement information and controls the navigation speed of the aircraft through the rotational speed information. In this and some other embodiments, the display unit 250 is a liquid crystal display, and the information produced during the manipulation, for example, power information or a navigational status of the aircraft, is displayed directly. In some other embodiments, the display unit 250 is a light emitting diode, and the information produced during the manipulation is reminded to the user by turning the light emitting diode on or turning the light emitting diode off.

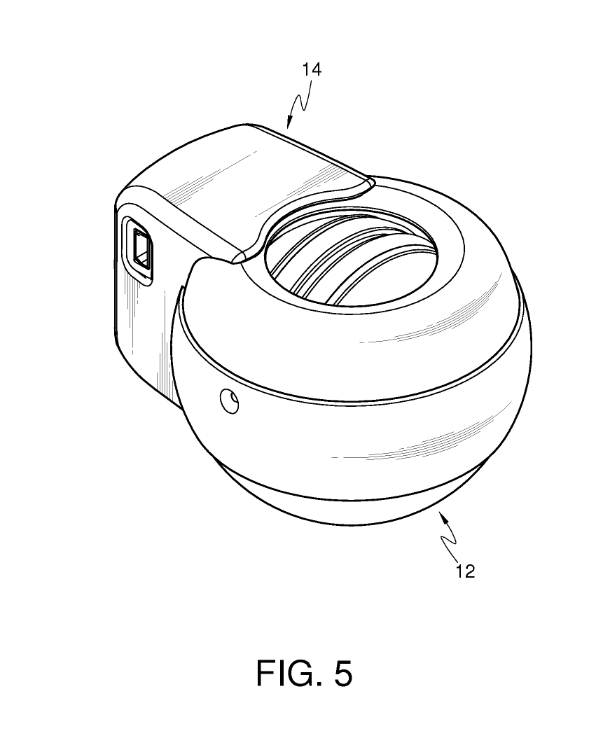

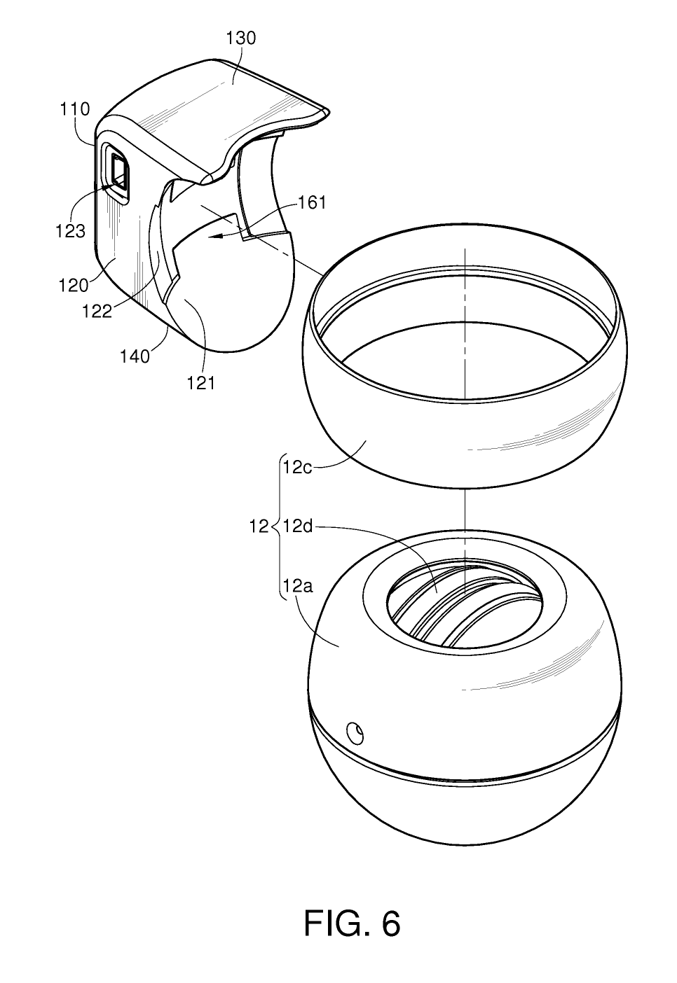

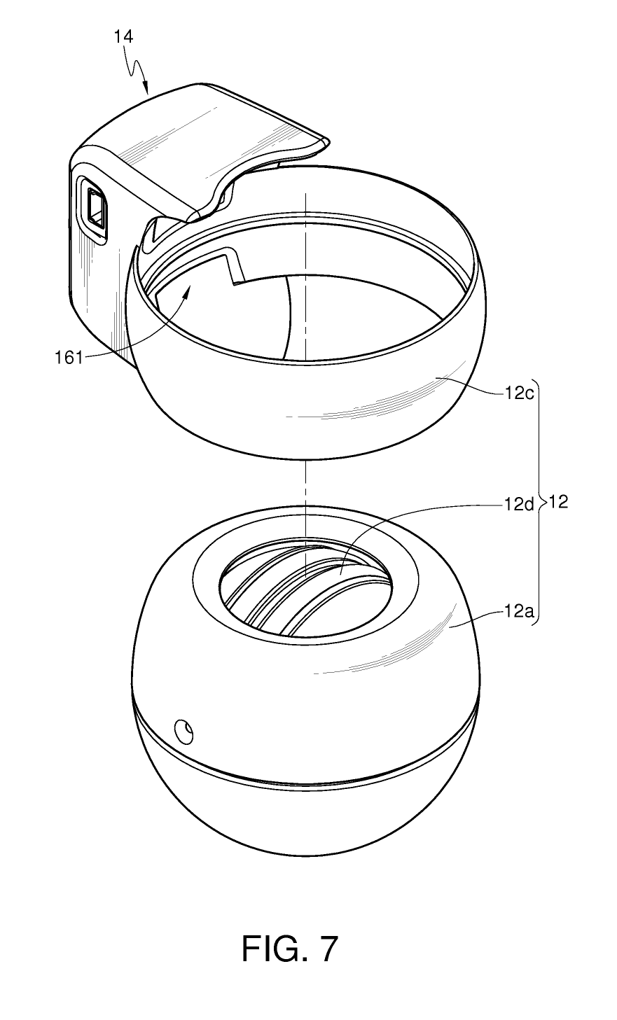

Please refer to FIG. 2, FIG. 5 to FIG. 7, FIG. 5 is a schematic 3D view of an electronic auxiliary device and a wrist strength training device having the same according to another embodiment; FIG. 6 is a schematic exploded view of FIG. 5; FIG. 7 is a schematic 3D view of a ring cover and buckle structures in FIG. 6 being joined. In this embodiment and some other embodiments, the combination of the electronic auxiliary device and the wrist strength training device 10 comprises a wrist strength training device 12 and an electronic auxiliary device 14. The electronic auxiliary device 14 in this embodiment is similar to the electronic auxiliary device 14 in FIG. 2, so mainly the differences are described in this embodiment.

The electronic auxiliary device 14 in this embodiment comprises a device body 100 and a function device 200. The device body 100 comprises a lateral wall 110, two sidewalls 120, a top wall 130, and a bottom wall 140. The lateral wall 110, the two sidewalls 120, the top wall 130, and the bottom wall 140 define an accommodating chamber 150.

In this embodiment, the auxiliary unit is, for example, a fixing plate. A pair of buckle structures 161 is disposed between the two sidewalls 120. The opposite two ends of the pair of buckle structures 161 are connected to the two sidewalls 120, respectively. One of the buckle structures 161 extends from the top wall 130 to the bottom wall 140, and the other buckle structures 161 extends from the bottom wall 140 to the top wall 130. Therefore, a plurality of slots is formed between the pair of buckle structures 161 and the sidewalls 120. The pair of buckle structures 161 is separated to each other by an interval, and the ring cover 12c is disposed between the plurality of slots through the interval so as to join the ring cover 12c and the device body 100 together. Next, by joining the ring cover 12c and the wrist strength training device 12, the electronic auxiliary device 14 is disposed at the wrist strength training device 12.

In particular, in order to dispose the electronic auxiliary device 14 at the ball body 12a, the ring cover 12c is first disposed on the buckle structures 161 (as FIG. 7), and then the ball body 12a is surrounded by the ring cover 12c (as FIG. 5).

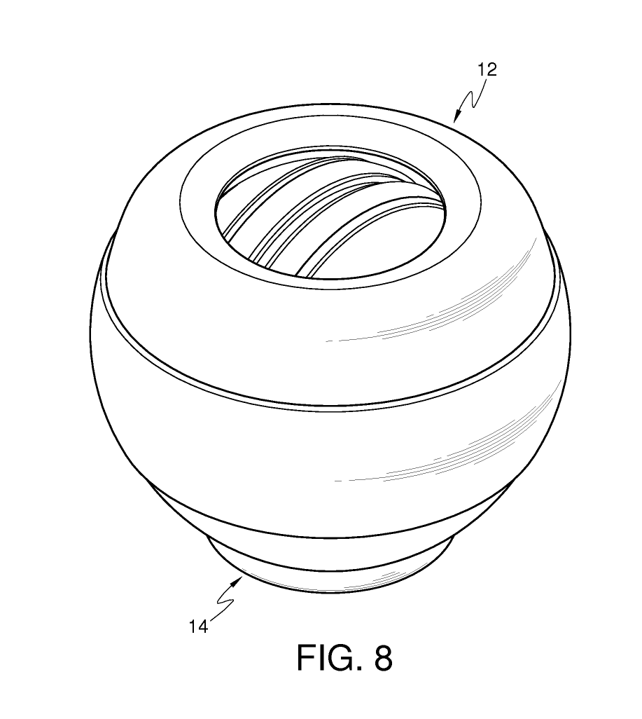

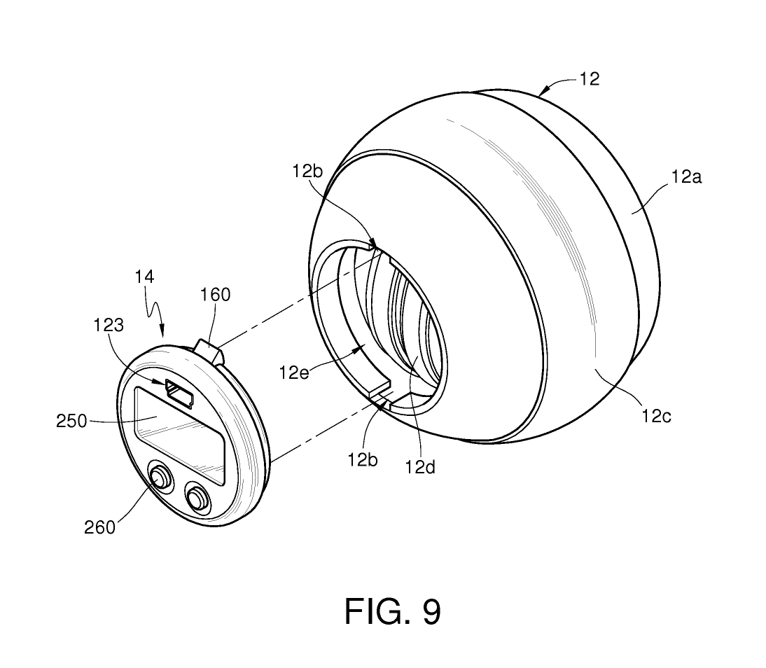

FIG. 8 is a schematic perspective view of a wrist exerciser with an electronic auxiliary device and a wrist strength training device according to an embodiment of the disclosure, and FIG. 9 is a schematic exploded view of FIG. 8. Referring to FIG. 8 and FIG. 9, a wrist exerciser 10, for being wirelessly coupled to an information device, includes a wrist strength training device 12 having an opening 12e and an electronic auxiliary device 14 for being inserted into the opening 12e of the wrist strength training device 12. Specifically, the wrist strength training device 12 includes a rotating body 12d and a ball body 12a which function as a shell for protecting other components inside the wrist strength training device 12. The opening 12e is formed on a side of the ball body 12a and extends through the ball body 12a. Hence, the rotating body 12d is exposed to an outside of the rotating body 12d through the opening 12e.

In this embodiment, the electronic auxiliary device 14 is substantially flushed with the opening 12e of the wrist strength training device 12. In detail, a part of the electronic auxiliary device 14 is located at an outside of the electronic auxiliary device 14, and the other part of the electronic auxiliary device 14 is located inside of the electronic auxiliary device 14. In some other embodiments, the electronic auxiliary device 14 is entirely flushed with the opening 12e of the wrist strength training device 12.

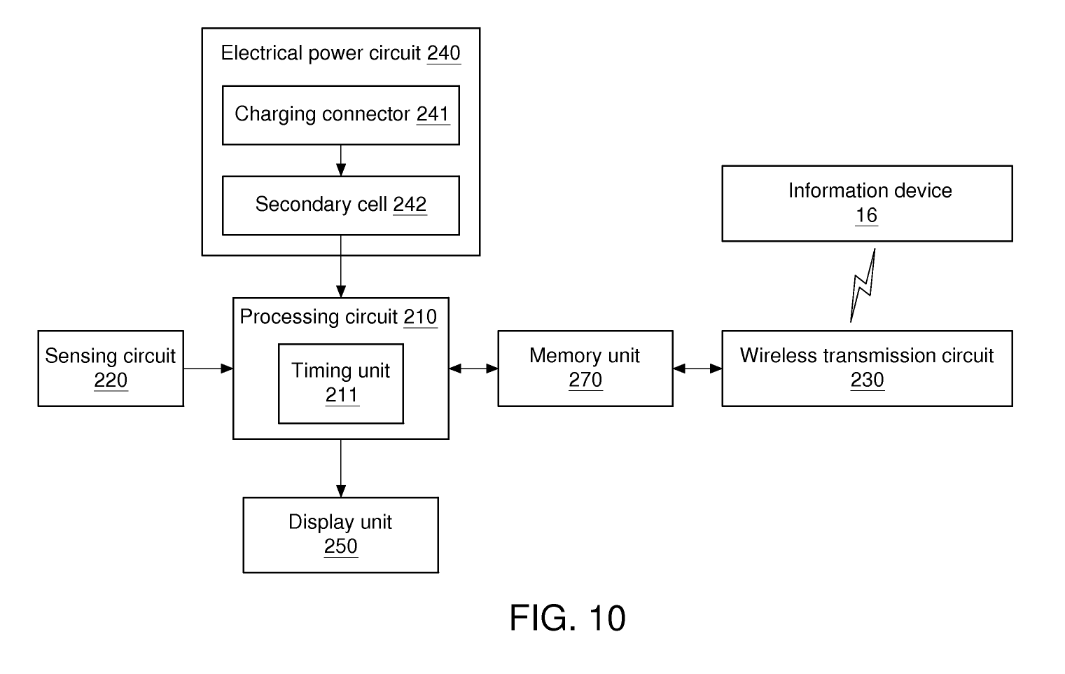

FIG. 10 is a block diagram of a function device of FIG. 8. Referring to FIG. 8 to FIG. 10, the electronic auxiliary device 14 includes a device body 100 and a function device 200 disposed inside the device body 100. Specifically, the device body 100 further includes a hook 160 for fastening to a slot 12b located at the periphery of the opening 12e of the wrist strength training device 12. The function device 200 includes a processing circuit 210, at least one sensing circuit 220, a wireless transmission circuit 230 and an electrical power circuit 240. The sensing circuit 220 is coupled to the processing circuit 210 and for acquiring exercise information of the wrist strength training device 12. The wireless transmission circuit 230 is coupled to the processing circuit 210 and for receiving or transmitting a wireless signal. The electrical power circuit 240 is coupled to the processing circuit 210 and for supplying electrical power.

The function device 200 is for acquiring the exercise information and transmitting the exercise information to the information device 16 wirelessly. Accordingly, embedded entirely into the opening 12e of the wrist strength training device 12, the electronic auxiliary device 14 is miniaturized, such that the wrist strength training device 12 and the electronic auxiliary device 14 are easy for a user to hold them.

The information device 16 is for notifying exercise information to a user. For example, the information device 16 is a desktop computer, a laptop computer, a portable device or a wearable device. For example, the portable device is a tablet computer, a smart phone. For example, the wearable device is a glass, a watch or a wrist band.

In this and some embodiments, the function device 200 further comprises at least one display unit 250, at least one control unit 260, a memory unit 270 and a timing unit 211. For example, the display unit 250 is for displaying the exercise information and is a liquid crystal display or a light emitting diode. The electrical power circuit 240 includes a charging connector 241 and a secondary cell 242. The charging connector 241 and the secondary cell 242 are electrically connected to each other. For example, the charging connector 241 is a mini USB port. The mini USB port is able to receive power or transmit and receive signals. Functions of the control unit 260, the memory unit 270, the timing unit 211, the charging connector 241 and the secondary cell 242 are the same as those of the aforementioned embodiments, so the repeated description is not described herein again.

In this embodiment, a user is able to train his/her wrist with the wrist exerciser 10, and the user is able to easily observe the exercise information shown by the information device 16 instead of by the wrist exerciser 10 itself which may be spun.

In this and some embodiments, for example, the sensing circuit 220 has a tachometer. In other embodiments, for example, the sensing circuit 220 has an accelerometer.

In this and some embodiments, for example, the wireless transmission circuit 230 is an RF module circuit, a Bluetooth transmission module circuit, or an IEEE 802 standard wireless transmission module circuit.

In this embodiment, a user is able to train his/her wrist with the wrist exerciser 10, and the user is able to easily observe the exercise information shown by the information device 16 rather than by the wrist exerciser 10 itself which may be spun.

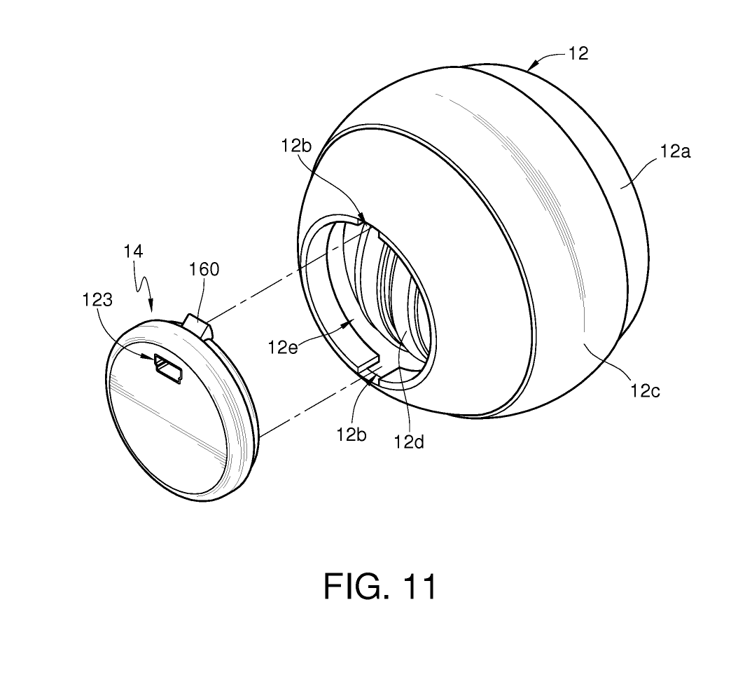

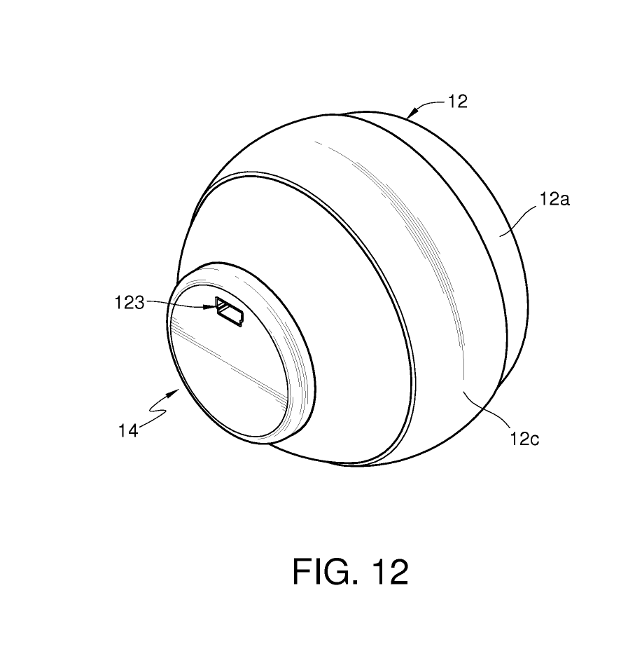

Please refer to FIG. 11 and FIG. 12. FIG. 11 is a schematic exploded view of an electronic auxiliary device and a wrist strength training device according to an embodiment. FIG. 12 is a schematic perspective view of FIG. 11. In this embodiment, the electronic auxiliary device 14 is substantially flushed with the opening 12e of the wrist strength training device 12. In detail, most parts of the electronic auxiliary device 14 are located at inside of the electronic auxiliary device 14. Moreover, compared to the embodiment shown in FIG. 8 through FIG. 10, the electronic auxiliary device 14 in this embodiment includes the opening 123 but does not include the display unit 250 and the control unit 260 on an outer surface of the electronic auxiliary device 14. That is, the opening 123 can expose the charging connector (not shown).

According to the embodiments of the disclosure, the electronic auxiliary device and the wrist strength training device having the same are joined by an auxiliary unit. Therefore, a user is able to acquire the exercise information of the wrist strength training device through a function device of the electronic auxiliary device. The electronic auxiliary device is disposed at the wrist strength training device to enable the wrist strength training device to operate an application program inside an information device through the exercise information, thereby achieving both training and entertaining effects.

In addition, the exercise information is transmitted to the information device through the wireless transmission circuit of the electronic auxiliary device for analysis or computation to obtain a training result (for example, an amount of the exercise or the calorie burned per period of time of the exercise).

What is claimed is:

1. A wrist exerciser, for being wirelessly coupled to an information device, comprising:
a wrist strength training device having an opening; and
an electronic auxiliary device for being inserted into the opening of the wrist strength training device and comprising:
a device body; and
a function device disposed inside the device body and comprising:
a processing circuit;
at least one sensing circuit coupled to the processing circuit and for acquiring exercise information of the wrist strength training device;
a wireless transmission circuit coupled to the processing circuit and for receiving or transmitting a wireless signal; and
an electrical power circuit coupled to the processing circuit and for supplying electrical power;
wherein the function device is for acquiring the exercise information and transmitting the exercise information to the information device wirelessly.

2. The wrist exerciser according to claim 1, wherein the function device further comprises at least one display unit.

3. The wrist exerciser according to claim 2, wherein the display unit is a liquid crystal display.

4. The wrist exerciser according to claim 2, wherein the display unit is a light emitting diode.

5. The wrist exerciser according to claim 1, wherein the function device further comprises at least one control unit.

6. The wrist exerciser according to claim 1, wherein the function device further comprises a memory unit.

7. The wrist exerciser according to claim 1, wherein the processing circuit comprises a timing unit.

8. The wrist exerciser according to claim 1, wherein the sensing circuit has a tachometer.

9. The wrist exerciser according to claim 1, wherein the sensing circuit has an accelerometer.

10. The wrist exerciser according to claim 1, wherein the wireless transmission circuit is a radio frequency (RF) module circuit, a Bluetooth transmission module circuit, or an US Institute of Electrical and Electronics Engineers 802 standard wireless transmission module circuit.

11. The wrist exerciser according to claim 1, wherein the device body further comprises a hook for fastening a slot located at the opening of the wrist strength training device.

12. The wrist exerciser according to claim 1, wherein the function device further comprises a charging connector and a secondary cell, and the charging connector and the secondary cell are electrically connected to each other.

13. The wrist exerciser according to claim 1, wherein the electronic auxiliary device being substantially flushed with the opening of the wrist strength training device.
